(19) United States
(12) Patent Application Publication
(10) Pub. No.: US 2017/0166841 A1
(43) Pub. Date: Jun. 15, 2017

(54) LIQUID LAUNDRY DETERGENT COMPOSITION

(71) Applicant: The Procter & Gamble Company, Cincinnati, OH (US)

(72) Inventors: Lucia FERNANDEZ MARTINEZ, Brussels (BE); Nigel Patrick SOMERVILLE ROBERTS, Newcastle upon Tyne (GB); Alan Thomas BROOKER, Newcastle upon Tyne (GB); James Edward STEELE CATER, Brussels (BE)

(21) Appl. No.: 15/372,428

(22) Filed: Dec. 8, 2016

(30) Foreign Application Priority Data
Dec. 10, 2015 (EP) 15199366.4
Nov. 1, 2016 (EP) 16196750.0

(51) Int. Cl. C11D 3/37; C11D 11/00; C11D 1/29; C11D 1/22; C11D 3/20

(52) U.S. Cl. CPC C11D 3/3788; C11D 1/22; C11D 3/2065; C11D 3/2044; C11D 1/29; C11D 11/0017

(57) ABSTRACT

Liquid laundry detergent compositions including a polymer including a polyester terephthalate backbone grafted with one or more anionic groups.

### FIELD OF THE INVENTION

The present invention relates to liquid laundry detergent compositions comprising a polymer comprising a polyester terephthalate backbone grafted with one or more anionic groups.

### BACKGROUND OF THE INVENTION

Polymers comprising a polyester terephthalate backbone grafted with one or more anionic groups are known to provide certain fabric cleaning benefits when formulated into laundry detergent compositions. Such laundry detergent compositions comprise anionic surfactants which are also required to provide a cleaning benefit.

A problem arises when attempts have been made to formulate such polymers into liquid laundry detergent compositions as the addition of the polymer results in formation of aggregates which can be visually seen in the composition. These aggregates have a negative effect on the aesthetics of the formulation and are perceived by consumers as meaning the composition is not stable and has phase split. Furthermore, during manufacture these aggregates can block pipes and nozzles and so negatively impact the ability to make the composition.

Therefore, there is a need in the art for a liquid laundry detergent composition comprising a polymer wherein the polymer comprises a polyester terephthalate backbone grafted with one or more anionic groups, wherein the formation of aggregates in the liquid laundry detergent composition is minimized.

It was surprisingly found that the liquid laundry detergent composition according to the present invention exhibited minimal aggregate formation even though it comprised a polymer comprising a polyester terephthalate backbone grafted with one or more anionic groups.

### SUMMARY OF THE INVENTION

A first aspect of the present invention is a liquid laundry detergent composition comprising anionic surfactant, water, glycerol, an alcohol and a polymer comprising a polyester terephthalate backbone grafted with one or more anionic groups;

wherein the composition is obtained by the following steps;
i) preparing a first composition comprising the anionic surfactant, water and glycerol;
ii) preparing a second composition comprising the alcohol and the polymer comprising a polyester terephthalate backbone grafted with one or more anionic groups, by preparing the alcohol and adding the polymer comprising a polyester terephthalate backbone grafted with one or more anionic groups to the alcohol;
iii) mixing the first and second compositions together.;

wherein the alcohol is selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal, dipropylene glycol, polypropylene glycol, dipropylene glycol n-butyl ether, and mixtures thereof, preferably the alcohol is selected from the group comprising 1,2 propanediol, dipropylene glycol, dipropylene glycol methyl ether, polypropylene glycol, 2,3-butane diol, dipropylene glycol n-butyl ether and mixtures thereof.

A second aspect of the present invention is a liquid laundry detergent composition comprising;
a. 8% to 30 wt % by weight of the composition of an anionic surfactant, wherein the anionic surfactant preferably comprises a linear alkylbenzene sulphonate, alkoxylated alkyl sulphate or a mixture thereof;
b. 5% to 15% by weight of the composition of glycerol;
c. 5% and 15% by weight of the composition of water;
d. 5 and 15% by weight of the composition of an alcohol;
e. 0.01% to 1%, preferably between 0.05% to 0.7%, more preferably between 0.1% and 0.6% by weight of the composition of a polymer comprising a polyester terephthalate backbone grafted with one or more anionic groups;

wherein the alcohol is selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal, dipropylene glycol, polypropylene glycol, dipropylene glycol n-butyl ether, and mixtures thereof, preferably the alcohol is selected from the group comprising 1,2 propanediol, dipropylene glycol, dipropylene glycol methyl ether, polypropylene glycol, 2,3-butane diol, dipropylene glycol n-butyl ether and mixtures thereof.

A third aspect of the present invention is a water-soluble unit dose article comprising a water-soluble film and a liquid laundry detergent composition according to the present invention.

A fourth aspect of the present invention is the use of a composition comprising an alcohol and a polymer comprising a polyester terephthalate backbone grafted with one or more anionic groups, for minimising aggregate formation during the manufacture of a liquid laundry detergent composition.

A fifth aspect of the present invention is a process of making a liquid laundry detergent composition according to the present invention;

wherein the composition is obtained by the following steps;
i) preparing a first composition comprising the anionic surfactant, water and glycerol;
ii) preparing a second composition comprising the alcohol and the polymer comprising a polyester terephthalate backbone grafted with one or more anionic groups, by preparing the alcohol and adding the polymer comprising a polyester terephthalate backbone grafted with one or more anionic groups to the alcohol;
iii) mixing the first and second compositions together.;

wherein the alcohol is selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal, dipropylene glycol, polypropylene glycol, dipropylene glycol n-butyl ether, and mixtures thereof, preferably the alcohol is selected from the group comprising 1,2 propanediol, dipropylene glycol, dipropylene glycol methyl ether, polypropylene glycol, 2,3-butane diol, dipropylene glycol n-butyl ether and mixtures thereof.

### DETAILED DESCRIPTION OF THE INVENTION

### Liquid Laundry Detergent Composition

The present invention is to a liquid laundry detergent composition comprising anionic surfactant, water, glycerol, an alcohol and a polymer comprising a polyester terephthalate backbone grafted with one or more anionic groups.

The term ‘liquid laundry detergent composition’ refers to any laundry detergent composition comprising a liquid capable of wetting and treating fabric e.g., cleaning clothing in a domestic washing machine, and includes, but is not limited to, liquids, gels, pastes, dispersions and the like. The liquid composition can include solids or gases in suitably subdivided form, but the liquid composition excludes forms which are non-fluid overall, such as tablets or granules.

The liquid composition may be formulated into a unit dose article. The unit dose article of the present invention comprises a water-soluble film which fully encloses the liquid composition in at least one compartment. Suitable unit dose articles are described in more detail below.

The liquid laundry detergent composition can be used as a fully formulated consumer product, or may be added to one or more further ingredient to form a fully formulated consumer product. The liquid laundry detergent composition may be a ‘pre-treat’ composition which is added to a fabric, preferably a fabric stain, ahead of the fabric being added to a wash liquor.

The liquid laundry detergent composition can be used in a fabric hand wash operation or may be used in an automatic machine fabric wash operation.

The composition is obtained by the following steps;
i) preparing a first composition comprising the anionic surfactant, water and glycerol;
ii) preparing a second composition comprising the alcohol and the polymer comprising a polyester terephthalate backbone grafted with one or more anionic groups, by preparing the alcohol and adding the polymer comprising a polyester terephthalate backbone grafted with one or more anionic groups to the alcohol;
iii) mixing the first and second compositions together.

Without wishing to be bound by theory, it is believed that the technical problem addressed by the present invention is overcome by the specific sequence of steps used to make the composition including the formation of first and second compositions.

The first and second compositions are described in more detail below.

Preferably, the liquid laundry detergent composition is transparent. By transparent we herein mean a composition having 50% transmittance or greater of light using 1 cm cuvette at Wavelength of 410-800 nanometers. Those skilled in the art would be aware of standard procedures and equipment to measure light transmittance.

Preferably, the first and second compositions are mixed by adding the second composition to the first composition.

The present invention is also to a liquid laundry detergent composition comprising;
a. 8% to 30 wt % by weight of the composition of an anionic surfactant, wherein the anionic surfactant preferably comprises a linear alkylbenzene sulphonate, alkoxylated alkyl sulphate or a mixture thereof;
b. 5% to 15% by weight of the composition of glycerol;
c. 5% and 15% by weight of the composition of water;
d. 5 and 15% by weight of the composition of an alcohol;
e. 0.01% to 1%, preferably between 0.05% to 0.7%, more preferably between 0.1% and 0.6% by weight of the composition of a polymer comprising a polyester terephthalate backbone grafted with one or more anionic groups.

The anionic surfactant is described in more detail below.

The alcohol is described in more detail below.

The polymer comprising a polyester terephthalate backbone grafted with one or more anionic groups.

The composition of the present invention may comprise an adjunct ingredient, preferably wherein the adjunct ingredient is selected from the group comprising bleach, bleach catalyst, dye, hueing dye, aesthetic dyes, cleaning polymers including alkoxylated polyamines and polyethyleneimines, surfactant, solvent, dye transfer inhibitors, chelant, perfume, encapsulated perfume, and mixtures thereof.

A further aspect of the present invention is a process of making a liquid laundry detergent composition according to the present invention;

wherein the composition is obtained by the following steps;

i) preparing a first composition comprising the anionic surfactant, water and glycerol;

ii) preparing a second composition comprising the alcohol and the polymer comprising a polyester terephthalate backbone grafted with one or more anionic groups, by preparing the alcohol and adding the polymer comprising a polyester terephthalate backbone grafted with one or more anionic groups to the alcohol;

iii) mixing the first and second compositions together.;

wherein the alcohol is selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal, dipropylene glycol, polypropylene glycol, dipropylene glycol n-butyl ether, and mixtures thereof, preferably the alcohol is selected from the group comprising 1,2 propanediol, dipropylene glycol, dipropylene glycol methyl ether, polypropylene glycol, 2,3-butane diol, dipropylene glycol n-butyl ether and mixtures thereof.

### First Composition

The first composition comprises the anionic surfactant, water and glycerol. Preferably, the first composition comprises between 10% and 50%, more preferably between 15% and 45% by weight of the first composition of anionic surfactant. The anionic surfactant is described in more detail below, however the anionic surfactant is preferably selected from linear alkylbenzene sulphonate, alkoxylated alkyl sulphate or mixtures thereof.

The first composition comprises water. Preferably, the first composition comprises between 5% and 15%, preferably between 7.5% and 12.5% by weight of the first composition of water.

The first composition comprises glycerol. Preferably, the first composition comprises between 1% and 15%, preferably between 3% and 10% by weight of the first composition of glycerol.

The first composition may comprise an adjunct ingredient selected from the group comprising bleach, bleach catalyst, dye, hueing dye, aesthetic dyes, cleaning polymers including alkoxylated polyamines and polyethyleneimines, surfactant, solvent, dye transfer inhibitors, chelant, perfume, encapsulated perfume, and mixtures thereof.

### Second Composition

The second composition comprises a polymer wherein the polymer comprises a polyester terephthalate backbone grafted with one or more anionic groups. Preferably, the second composition comprises between 1% and 10%, preferably between 3% and 9%, more preferably between 4% and 8% by weight of the second composition of the polymer comprising a polyester terephthalate backbone grafted with one or more anionic groups. The polymer is described in more detail below.

The second composition comprises an alcohol. Preferably, the second composition comprises between 25% and 60%, more preferably between 30% and 50%, most preferably between 35% and 45% by weight of the second composition of the alcohol. The alcohol is described in more detail below.

The second composition comprises between 4% and 15%, preferably between 8% and 13% by weight of the second composition of water, preferably, wherein the second composition is prepared by adding the alcohol to the water followed by addition of the polymer to the water and alcohol mixture.

The second composition may comprise a non-ionic surfactant, a brightener or a mixture thereof.

### Anionic Surfactant

The anionic surfactant may be selected from linear alkybenzene sulphonate, alkoxylated alkyl sulphate, fatty acid or mixtures thereof.

Exemplary linear alkylbenzene sulphonates are C₁₀-C₁₆ alkyl benzene sulfonic acids, or C₁₁-C₁₄ alkyl benzene sulfonic acids. By ‘linear’, we herein mean the alkyl group is linear.

The alkoxylated alkyl sulphate anionic surfactant may be a C₁₀-C₁₈ alkyl ethoxy sulfate (AEₓS) wherein x is an average degree of ethoxylation of from 0.5 to 30, preferably between 1 and 10, more preferably between 1 and 5.

The term ‘fatty acid’ includes fatty acid or fatty acid salts. The fatty acids are preferably carboxylic acids which are often with a long unbranched aliphatic tail, which is either saturated or unsaturated. Suitable fatty acids include ethoxylated fatty acids. Suitable fatty acids or salts of the fatty acids for the present invention are preferably sodium salts, preferably C12-C18 saturated and/or unsaturated fatty acids more preferably C12-C14 saturated and/or unsaturated fatty acids and alkali or alkali earth metal carbonates preferably sodium carbonate.

Preferably the fatty acids are selected from the group consisting of lauric acid, myristic acid, palmitic acid, stearic acid, topped palm kernel fatty acid, coconut fatty acid and mixtures thereof.

### Non-Ionic Surfactant

Preferably, the non-ionic surfactant comprises a fatty alcohol alkoxylate, an oxo-synthesised fatty alcohol alkoxylate, Guerbet alcohol alkoxylates, alkyl phenol alcohol alkoxylates or a mixture thereof. The ethoxylated nonionic surfactant may be, e.g., primary and secondary alcohol ethoxylates, especially the C₈-C₂₀ aliphatic alcohols ethoxylated with an average of from 1 to 50 or even 20 moles of ethylene oxide per mole of alcohol, and more especially the C₁₀-C₁₅ primary and secondary aliphatic alcohols ethoxylated with an average of from 1 to 10 moles of ethylene oxide per mole of alcohol.

The ethoxylated alcohol non-ionic surfactant can be, for example, a condensation product of from 3 to 8 mol of ethylene oxide with 1 mol of a primary alcohol having from 9 to 15 carbon atoms.

The non-ionic surfactant may comprise a fatty alcohol ethoxylate of formula R(EO)ₙ, wherein R represents an alkyl chain between 4 and 30 carbon atoms, (EO) represents one unit of ethylene oxide monomer and n has an average value between 0.5 and 20.

### Polymer

The polymer comprises a polyester terephthalate backbone grafted with one or more anionic groups. Suitable polymers have a structure as defined by one of the following structures

(I), (II) or (III):

—[(OCHR¹—CHR²)ₐ—O—OC—Ar—CO—]_{d} (I)

—[(OCHR³—CHR⁴)_{b}—O—OC-sAr—CO—]ₑ (II)

—[(OCHR⁵—CHR⁶)_{c}—OR⁷]_{f} (III)

wherein:
a, b and c are from 1 to 200;
d, e and f are from 1 to 50, preferably from 2 to 50;
Ar is a 1,4-substituted phenylene;
sAr is 1,3-substituted phenylene substituted in position 5 with SO₃Me;
Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;
R¹, R², R³, R⁴, R⁵and R⁶ are independently selected from H or C₁-C₁₈ n- or iso-alkyl; and
R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.
Suitable soil release polymers are sold by Clariant under the TexCare® series of polymers, e.g. TexCare® SRN240 and TexCare® SRA300. Other suitable soil release polymers are sold by Solvay under the Repel-o-Tex® series of polymers, e.g. Repel-o-Tex® SF2 and Repel-o-Tex® Crystal.

### Alcohol

The alcohol has a molecular weight of between 20 and 400 and an eRH of between 50% and 80% preferably between 52% and 75% at 20° C. as measured via the alcohol eRH test described herein.

The alcohol eRH test comprises the steps of preparing a solution of 80% alcohol in deionised water, followed by adding this to a calibrated Rotronic Hygrolab meter (in a plastic sample liner of 14 mm depth) at room temperature (20° C.+/−1° C.) and allowing this to equilibrate for 25 minutes, and finally measuring the eRH recorded. The volume of sample used was sufficient to fill the plastic sample liner.

By ‘alcohol’ we herein mean either a single compound or a mixture of compounds that when taken together collectively each have a molecular weight of between 20 and 400 and an overall eRH of the compound or mixture of between 50% and 80% at 20° C. as measured via the eRH test. Without wishing to be bound by theory, an alcohol is any compound comprising at least one OH unit, preferably polyols and diols, more preferably diols. Preferred diols included glycols.

Preferably, the alcohol may be selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal, dipropylene glycol, polypropylene glycol, dipropylene glycol n-butyl ether, and mixtures thereof.

More preferably, the alcohol may be selected from the group comprising ethylene glycol, 1,2 propanediol, 2,3-butane diol, 1,3 butanediol, triethylene glycol, polyethylene glycol, glycerol formal, dipropylene glycol, polypropylene glycol, dipropylene glycol n-butyl ether, and mixtures thereof.

Even more preferably the alcohol is selected from the group comprising 1,2 propanediol, dipropylene glycol, polypropylene glycol, 2,3- butane diol, dipropylene glycol n-butyl ether and mixtures thereof.

Most preferably the alcohol may be selected from the group comprising 1,2 propanediol, dipropylene glycol, polypropylene glycol, dipropylene glycol n-butyl ether and mixtures thereof.

One aspect of the present invention is a liquid laundry detergent composition comprising anionic surfactant, water, glycerol, an alcohol and a polymer comprising a polyester terephthalate backbone grafted with one or more anionic groups;

wherein the composition is obtained by the following steps;
i) preparing a first composition comprising the anionic surfactant, water and glycerol;
ii) preparing a second composition comprising the alcohol and the polymer comprising a polyester terephthalate backbone grafted with one or more anionic groups, by preparing the alcohol and adding the polymer comprising a polyester terephthalate backbone grafted with one or more anionic groups to the alcohol;
iii) mixing the first and second compositions together.;
   wherein the alcohol is selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal dipropylene glycol, polypropylene glycol, dipropylene glycol n-butyl ether, and mixtures thereof, preferably the alcohol is selected from the group comprising 1,2 propanediol, dipropylene glycol, dipropylene glycol methyl ether, polypropylene glycol, 2,3- butane diol, dipropylene glycol n-butyl ether and mixtures thereof.

### Unit Dose Article

The present invention is also to a water-soluble unit dose article comprising a water-soluble film and the liquid laundry detergent composition of the present invention. The water-soluble unit dose article comprises at least one water-soluble film shaped such that the unit-dose article comprises at least one internal compartment surrounded by the water-soluble film. The at least one compartment comprises the liquid laundry detergent composition. The water-soluble film is sealed such that the liquid laundry detergent composition does not leak out of the compartment during storage. However, upon addition of the water-soluble unit dose article to water, the water-soluble film dissolves and releases the contents of the internal compartment into the wash liquor.

The compartment should be understood as meaning a closed internal space within the unit dose article, which holds the composition. Preferably, the unit dose article comprises a water-soluble film. The unit dose article is manufactured such that the water-soluble film completely surrounds the composition and in doing so defines the compartment in which the composition resides. The unit dose article may comprise two films. A first film may be shaped to comprise an open compartment into which the composition is added. A second film is then laid over the first film in such an orientation as to close the opening of the compartment. The first and second films are then sealed together along a seal region. The film is described in more detail below.

The unit dose article may comprise more than one compartment, even at least two compartments, or even at least three compartments. The compartments may be arranged in superposed orientation, i.e. one positioned on top of the other. Alternatively, the compartments may be positioned in a side-by-side orientation, i.e. one orientated next to the other. The compartments may even be orientated in a ‘tyre and rim’ arrangement, i.e. a first compartment is positioned next to a second compartment, but the first compartment at least partially surrounds the second compartment, but does not completely enclose the second compartment. Alternatively one compartment may be completely enclosed within another compartment.

Wherein the unit dose article comprises at least two compartments, one of the compartments may be smaller than the other compartment. Wherein the unit dose article comprises at least three compartments, two of the compartments may be smaller than the third compartment, and preferably the smaller compartments are superposed on the larger compartment. The superposed compartments preferably are orientated side-by-side.

In a multi-compartment orientation, the composition according to the present invention may be comprised in at least one of the compartments. It may for example be comprised in just one compartment, or may be comprised in two compartments, or even in three compartments.

The film of the present invention is soluble or dispersible in water. The water-soluble film preferably has a thickness of from 20 to 150 micron, preferably 35 to 125 micron, even more preferably 50 to 110 micron, most preferably about 76 micron.

Preferably, the film has a water-solubility of at least 50%, preferably at least 75% or even at least 95%, as measured by the method set out here after using a glass-filter with a maximum pore size of 20 microns:

5 grams±0.1 gram of film material is added in a pre-weighed 3 L beaker and 2 L±5 ml of distilled water is added. This is stirred vigorously on a magnetic stirrer, Labline model No. 1250 or equivalent and 5 cm magnetic stirrer, set at 600 rpm, for 30 minutes at 30° C. Then, the mixture is filtered through a folded qualitative sintered-glass filter with a pore size as defined above (max. 20 micron). The water is dried off from the collected filtrate by any conventional method, and the weight of the remaining material is determined (which is the dissolved or dispersed fraction). Then, the percentage solubility or dispersability can be calculated.

Preferred film materials are preferably polymeric materials. The film material can, for example, be obtained by casting, blow-moulding, extrusion or blown extrusion of the polymeric material, as known in the art.

Preferred polymers, copolymers or derivatives thereof suitable for use as pouch material are selected from polyvinyl alcohols, polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum. More preferred polymers are selected from polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, and most preferably selected from polyvinyl alcohols, polyvinyl alcohol copolymers and hydroxypropyl methyl cellulose (HPMC), and combinations thereof. Preferably, the level of polymer in the pouch material, for example a PVA polymer, is at least 60%. The polymer can have any weight average molecular weight, preferably from about 1000 to 1,000,000, more preferably from about 10,000 to 300,000 yet more preferably from about 20,000 to 150,000.

Mixtures of polymers can also be used as the pouch material. This can be beneficial to control the mechanical and/or dissolution properties of the compartments or pouch, depending on the application thereof and the required needs. Suitable mixtures include for example mixtures wherein one polymer has a higher water-solubility than another polymer, and/or one polymer has a higher mechanical strength than another polymer. Also suitable are mixtures of polymers having different weight average molecular weights, for example a mixture of PVA or a copolymer thereof of a weight average molecular weight of about 10,000-40,000, preferably around 20,000, and of PVA or copolymer thereof, with a weight average molecular weight of about 100,000 to 300,000, preferably around 150,000. Also suitable herein are polymer blend compositions, for example comprising hydrolytically degradable and water-soluble polymer blends such as polylactide and polyvinyl alcohol, obtained by mixing polylactide and polyvinyl alcohol, typically comprising about 1-35% by weight polylactide and about 65% to 99% by weight polyvinyl alcohol. Preferred for use herein are polymers which are from about 60% to about 98% hydrolysed, preferably about 80% to about 90% hydrolysed, to improve the dissolution characteristics of the material.

Preferred films exhibit good dissolution in cold water, meaning unheated distilled water. Preferably such films exhibit good dissolution at temperatures of 24° C., even more preferably at 10° C. By good dissolution it is meant that the film exhibits water-solubility of at least 50%, preferably at least 75% or even at least 95%, as measured by the method set out here after using a glass-filter with a maximum pore size of 20 microns, described above.

Preferred films are those supplied by Monosol under the trade references M8630, M8900, M8779, M8310.

Of the total PVA resin content in the film described herein, the PVA resin can comprise about 30 to about 85 wt % of the first PVA polymer, or about 45 to about 55 wt % of the first PVA polymer. For example, the PVA resin can contain about 50 w. % of each PVA polymer, wherein the viscosity of the first PVA polymer is about 13 cP and the viscosity of the second PVA polymer is about 23 cP.

Naturally, different film material and/or films of different thickness may be employed in making the compartments of the present invention. A benefit in selecting different films is that the resulting compartments may exhibit different solubility or release characteristics.

The film material herein can also comprise one or more additive ingredients. For example, it can be beneficial to add plasticisers, for example glycerol, ethylene glycol, diethyleneglycol, propylene glycol, sorbitol and mixtures thereof. Other additives may include water and functional detergent additives, including surfactant, to be delivered to the wash water, for example organic polymeric dispersants, etc.

The film may be opaque, transparent or translucent. The film may comprise a printed area. The printed area may cover between 10 and 80% of the surface of the film; or between 10 and 80% of the surface of the film that is in contact with the internal space of the compartment; or between 10 and 80% of the surface of the film and between 10 and 80% of the surface of the compartment.

The area of print may cover an uninterrupted portion of the film or it may cover parts thereof, i.e. comprise smaller areas of print, the sum of which represents between 10 and 80% of the surface of the film or the surface of the film in contact with the internal space of the compartment or both.

The area of print may comprise inks, pigments, dyes, blueing agents or mixtures thereof. The area of print may be opaque, translucent or transparent.

The area of print may comprise a single colour or maybe comprise multiple colours, even three colours. The area of print may comprise white, black, blue, red colours, or a mixture thereof. The print may be present as a layer on the surface of the film or may at least partially penetrate into the film. The film will comprise a first side and a second side. The area of print may be present on either side of the film, or be present on both sides of the film. Alternatively, the area of print may be at least partially comprised within the film itself.

The area of print may comprise an ink, wherein the ink comprises a pigment. The ink for printing onto the film has preferably a desired dispersion grade in water. The ink may be of any color including white, red, and black. The ink may be a water-based ink comprising from 10% to 80% or from 20% to 60% or from 25% to 45% per weight of water. The ink may comprise from 20% to 90% or from 40% to 80% or from 50% to 75% per weight of solid.

The ink may have a viscosity measured at 20° C. with a shear rate of 1000 s⁻¹ between 1 and 600 cPs or between 50 and 350 cPs or between 100 and 300 cPs or between 150 and 250 cPs. The measurement may be obtained with a cone-plate geometry on a TA instruments AR-550 Rheometer.

The area of print may be achieved using standard techniques, such as flexographic printing or inkjet printing. Preferably, the area of print is achieved via flexographic printing, in which a film is printed, then moulded into the shape of an open compartment. This compartment is then filled with a detergent composition and a second film placed over the compartment and sealed to the first film. The area of print may be on either or both sides of the film.

Alternatively, an ink or pigment may be added during the manufacture of the film such that all or at least part of the film is coloured.

The film may comprise an aversive agent, for example a bittering agent. Suitable bittering agents include, but are not limited to, naringin, sucrose octaacetate, quinine hydrochloride, denatonium benzoate, or mixtures thereof. Any suitable level of aversive agent may be used in the film. Suitable levels include, but are not limited to, 1 to 5000 ppm, or even 100 to 2500 ppm, or even 250 to 2000 rpm.

### Use

The present invention is also to the use of a composition comprising an alcohol and a polymer comprising a polyester terephthalate backbone grafted with one or more anionic groups, for minimising aggregate formation during the manufacture of a liquid laundry detergent composition.

The composition or unit dose article of the present invention can be added to a wash liquor to which laundry is already present, or to which laundry is added. It may be used in an washing machine operation and added directly to the drum or to the dispenser drawer. The washing machine may be an automatic or semi-automatic washing machine. It may be used in combination with other laundry detergent compositions such as fabric softeners or stain removers. It may be used as pre-treat composition on a stain prior to being added to a wash liquor.

### EXAMPLES

The presence of aggregates was investigated in various compositions.

The following compositions were prepared;

TABLE 1

| | Weight in grams | | |
|---|---|---|---|
| | Batch 1 | Batch 2 | Batch 3 |
| ‘Composition 1’ comprising anionic | 990 | 850 | 850 |
| surfactant, water and glycerol. | | | |
| ‘Composition 2’ containing polymer | 10 | 150 | 10 |
| comprising a polyester terephthalate | | | |
| backbone grafted with one or more anionic | | | |
| groups and an alcohol wherein the polymer | | | |
| was added to the alcohol | | | |
| polymer comprising a polyester terephthalate | | | |
| backbone grafted with one or more anionic | | | |
| groups | | | |
| alcohol | | | 50 |

The alcohol used was 1,2-propanediol.

In batches 1 and 3, a second composition was not prepared, rather the polymer and/or alcohol were added separately and directly to composition 1.

The compositions were prepared using an IKA EUROSTAR 200 with a 10 cm diameter impeller and mixed at 250 rpm. Ingredients were weighed using a Mettler Toledo PB3002-S
The presence of aggregates was measured via the following method;
1. Clean and dry a 150 micron sieve.
2. Make sure sample is homogeneous; shake it before passing it through the sieve.
3. Place 20 g of the relevant batch via syringe on the sieve, spread in line over sieve and record the weight.
4. Tap sieve lightly to allow product to flow through sieve. Light air or nitrogen may be blown over sample to help alleviate air bubbles trapped on the sieve.
5. Count the number of particles remaining on sieve after product has passed through sieve. Repeat counting 3 times. Take care to ensure that aggregates are counted and distinguished from air bubbles, additional air/nitrogen can be used if in question.
6. Divide average number of counts by weight used to get aggregation # per gram of sample.
7. Average the three readings of aggregation # per gram of sample for final product aggregation number.
8. Record #/g and count number of aggregates.

An aggregate is defined as a particle>150 micron. (100 micron is visible to the eye). Results can be seen in Table 2.

TABLE 2

| | Batch 1 | Batch 2 | Batch 3 |
|---|---|---|---|
| #aggregates replica1 | 1 | 0 | 110 |
| #aggregates replica2 | 2 | 0 | 123 |
| #aggregates replica3 | 1 | 0 | 132 |

As can be seen from Table 2, batch 2 resulted in no aggregates. If the formulation was not made according to the present invention, aggregates were formed.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid laundry detergent composition comprising anionic surfactant, water, glycerol, an alcohol, and a polymer comprising a polyester terephthalate backbone grafted with one or more anionic groups;
wherein the composition is obtained by the following steps:
i) preparing a first composition comprising the anionic surfactant, water and glycerol;
ii) preparing a second composition comprising the alcohol and the polymer comprising a polyester terephthalate backbone grafted with one or more anionic groups, by preparing the alcohol and adding the polymer comprising a polyester terephthalate backbone grafted with one or more anionic groups to the alcohol;
iii) mixing the first and second compositions together;
wherein the alcohol is selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal, dipropylene glycol, polypropylene glycol, dipropylene glycol n-butyl ether, and mixtures thereof.

2. The composition according to claim 1, wherein the alcohol is selected from the group comprising 1,2 propanediol, dipropylene glycol, dipropylene glycol methyl ether, polypropylene glycol, 2,3-butane diol, dipropylene glycol n-butyl ether and mixtures thereof.

3. The composition according to claim 1 wherein the composition is transparent.

4. The composition according to claim 1 wherein the first composition comprises between 10% and 50%, by weight of the first composition, of anionic surfactant.

5. The composition according to claim 4, wherein the anionic surfactant is selected from linear alkylbenzene sulphonate, alkoxylated alkyl sulphate or mixtures thereof.

6. The composition according to claim 1 wherein the first composition comprises between 5% and 15%, by weight of the first composition, of water.

7. The composition according to claim 1 wherein the first composition comprises between 1% and 15%, by weight of the first composition, of glycerol.

8. The composition according to claim 1 wherein the second composition comprises between 1% and 10%, by weight of the second composition, of the polymer.

9. The composition according to claim 1 wherein the second composition comprises between 25% and 60%, by weight of the second composition, of the alcohol.

10. The composition according to claim 1 wherein the second composition comprises between 4% and 15%, by weight of the second composition, of water, wherein the second composition is prepared by adding the alcohol to the water followed by addition of the polymer to the water and alcohol mixture.

11. The composition according to claim 1 wherein the second composition comprises a non-ionic surfactant, a brightener, or a mixture thereof.

12. The composition according to claim 1 wherein the second composition is added to the first composition.

13. The composition according to claim 1 wherein the composition comprises an adjunct ingredient selected from the group comprising bleach, bleach catalyst, dye, hueing dye, aesthetic dyes, alkoxylated polyamines, alkoxylated polyethyleneimines, surfactant, solvent, dye transfer inhibitors, chelant, perfume, encapsulated perfume, and mixtures thereof.

14. A liquid laundry detergent composition comprising:
a. 8% to 30 wt % by weight of the composition of an anionic surfactant;
b. 5% to 15% by weight of the composition of glycerol;
c. 5% and 15% by weight of the composition of water;
d. 5 and 15% by weight of the composition of an alcohol;
e. 0.01% to 1%, preferably between 0.05% to 0.7%, more preferably between 0.1% and 0.6% by weight of the composition of a polymer comprising a polyester terephthalate backbone grafted with one or more anionic groups;
wherein the alcohol is selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal, dipropylene glycol, polypropylene glycol, dipropylene glycol n-butyl ether, and mixtures thereof.

15. A liquid laundry detergent according to claim 14, wherein the anionic surfactant comprises a linear alkylbenzene sulphonate, alkoxylated alkyl sulphate, or a mixture thereof.

16. A liquid laundry detergent according to claim 14, wherein the alcohol is selected from the group comprising 1,2 propanediol, dipropylene glycol, dipropylene glycol methyl ether, polypropylene glycol, 2,3-butane diol, dipropylene glycol n-butyl ether and mixtures thereof.

17. A process of making a liquid laundry detergent composition:
wherein the composition is obtained by the following steps;
i) preparing a first composition comprising the anionic surfactant, water and glycerol;
ii) preparing a second composition comprising the alcohol and the polymer comprising a polyester terephthalate backbone grafted with one or more anionic groups, by preparing the alcohol and adding the polymer comprising a polyester terephthalate backbone grafted with one or more anionic groups to the alcohol;
iii) mixing the first and second compositions together;
wherein the alcohol is selected from the group comprising ethylene glycol, 1,3 propanediol, 1,2 propanediol, tetramethylene glycol, pentamethylene glycol, hexamethylene glycol, 2,3-butane diol, 1,3 butanediol, diethylene glycol, triethylene glycol, polyethylene glycol, glycerol formal, dipropylene glycol, polypropylene glycol, dipropylene glycol n-butyl ether, and mixtures thereof.

18. A process according to claim 17, where the alcohol is selected from the group comprising 1,2 propanediol, dipropylene glycol, dipropylene glycol methyl ether, polypropylene glycol, 2,3-butane diol, dipropylene glycol n-butyl ether, and mixtures thereof.

19. A water-soluble unit dose article comprising a water-soluble film and a liquid laundry detergent composition according to claim 1.
